(19) United States
(12) Patent Application Publication
(10) Pub. No.: US 2007/0244572 A1
(43) Pub. Date: Oct. 18, 2007

(54) AUTOMATION SYSTEMS AND METHODS

(76) Inventor: RYAN NEIL FARR, HOLLADAY, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/734,624

(22) Filed: Apr. 12, 2007

Related U.S. Application Data
(60) Provisional application No. 60/744,734, filed on Apr. 12, 2006.

(51) Int. Cl. G05B 11/01

(52) U.S. Cl. 700/12

(57) ABSTRACT

An automation system may include an automation module. The automation module is preferably configured to commence, maintain, and/or cease performing one or more automation actions in response to detecting user input, motion, proximity, other conditions, or any combination of one or more thereof. Exemplary automation actions include, but are not limited to, brightening lighting; darkening lighting; triggering a heating, ventilation, air conditioning (HVAC) system to provide air flow; triggering an HVAC system to alter the temperature in one or more rooms or other generally enclosed areas; providing electricity (or other resource) to a resource consuming device; withdrawing electricity (or other resource) from a resource consuming device; increasing an amount of electricity (or other resource) provided to a resource consuming device; decreasing an amount of electricity (or other resource) provided to a resource consuming device; activating a resource consuming device; and deactivating a resource consuming device.

### CROSS-REFERENCE TO RELATED APPLICATIONS

This application claims priority to and the benefit of U.S. provisional patent application Ser. No. 60/744,734, which was filed on Apr. 12, 2006 and entitled AUTOMATION SYSTEMS AND METHODS, the disclosure of which is incorporated by reference herein in its entirety.

### BACKGROUND

1. Field of the Invention

The present invention generally relates to automation systems for resource consuming devices, such as lighting systems and/or other systems.

2. Description of Related Art

Lighting systems are known. To help reduce energy consumption, certain lighting systems include motion sensors that may be configured to automatically illuminate the lighting systems for a period of time after motion is sensed. For example, as persons move within a room or along a hallway, the motion sensors may sense that motion and cause the lighting systems to illuminate the room or hallway.

Unfortunately, some lighting systems use motion sensors that are too sensitive. For example, some motion sensors may be unintentionally triggered, even when no persons are present. With these overly sensitive motion sensors, these lighting systems unintentionally consume energy, wasting money and hindering energy conservation.

Other lighting systems use motion sensors that are insufficiently sensitive. For example, these lighting systems may unintentionally darken when persons are present. To trigger the motion sensors to re-illuminate these lighting systems, these persons typically must exaggeratingly waive their arms—an annoying process that may reduce the productivity of these persons.

### BRIEF DESCRIPTION OF THE DRAWINGS

The appended drawings contain figures of preferred embodiments to further clarify aspects, advantages and features of the present invention. It will be appreciated that these drawings depict only preferred embodiments of the invention and are not intended to limits its scope. The preferred embodiments will be described and explained with additional specificity and detail through the use of the accompanying drawings in which:

FIG. 1 is a block diagram illustrating an exemplary embodiment of an automation system;

FIG. 2 is a flowchart illustrating an exemplary embodiment of an automation method;

FIG. 3 is a screenshot of an exemplary embodiment of a user interface;

FIG. 4 is a screenshot of an exemplary embodiment of a user interface;

FIG. 5 is a flowchart illustrating a further exemplary embodiment of a portion of the automation method shown in FIG. 2;

FIG. 6 is a block diagram illustrating an exemplary embodiment of an automation system;

FIG. 7 is a flowchart illustrating an exemplary embodiment of an automation method;

FIG. 8 is a screenshot of an exemplary embodiment of a user interface;

FIG. 9 is a screenshot of another exemplary embodiment of a user interface;

FIGS. 10A and 10B are flowcharts illustrating a further exemplary embodiment of a portion of the automation method shown in FIG. 7;

FIG. 11 is a block diagram illustrating an exemplary embodiment of an automation system;

FIG. 12 is a flowchart illustrating an exemplary embodiment of an automation method;

FIG. 13 is a screenshot of an exemplary embodiment of a user interface;

FIG. 14 is a screenshot of an exemplary embodiment of a user interface;

FIGS. 15A, 15B, and 15C are flowcharts illustrating a further exemplary embodiment of a portion of the automation method shown in FIG. 12;

FIG. 16 is a block diagram illustrating an exemplary embodiment of an automation system; and

FIG. 17 is a block diagram illustrating an exemplary embodiment of an automation system.

### DETAILED DESCRIPTION

Some embodiments of the present invention are generally directed towards a lighting system. However, the principles of the present invention are not limited to lighting systems. It will be understood that, in light of the present disclosure, the system disclosed herein can be successfully used in connection with other systems including other types of resource consuming devices and systems.

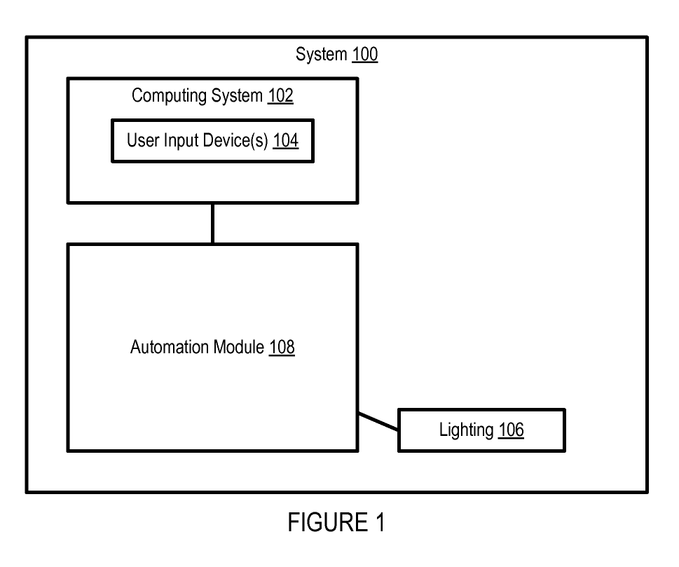

As shown in FIG. 1, an automation system 100 may include one or more computing systems 102. As used herein, the term “computing system” is a broad term and is used in its ordinary meaning and includes, but is not limited to, computers, personal computers, desktop computers, laptop computers, palmtop computers, general purpose computers, special purpose computers, network PCs, minicomputers, mainframe computers, and the like.

The computing system 102 preferably includes one or more user input devices 104. As used herein, the term “user input device” is a broad term and is used in its ordinary meaning and includes, but is not limited to, keyboards, keypads, mice, mouse touch pads, mouse knobs, mouse balls, mouse roller wheels, touch-sensitive screens (such as touch screens, touch pads, and the like), microphones, video cameras, and other devices a computing system may use to receive user input. As used herein, the term “user input” is a broad term and is used in its ordinary meaning and includes, but is not limited to, keystrokes, mouse movement, mouse clicks, touch input, audio, video and other user input that a user input device may be configured to receive. Thus, the computing system 102 may receive manually-entered user input (such as, keystrokes, mouse movement, mouse clicks, or touch input) via manual user input devices 104 (such as, keyboards, keypads, mice, mouse touch pads, mouse knobs, mouse balls, mouse roller wheels, touch-sensitive screens), and/or the computing system 102 may receive non-manually-entered user input (such as, audio or video) via non-manual user input devices 104 (such as, microphones or video cameras). The user input devices 104 may be physically, wirelessly, or otherwise connected to the computing system 102 in any suitable fashion that may permit the computing system 102 to receive user input via the user input devices 104.

The computing system 102 preferably includes one or more display devices (not shown) generally configured to provide a visual output of the computing system—such as monitors, touch-sensitive screens, and the like. The computing system 102 may also include one or more status devices (such as hard drive LEDs, on-off switch LEDs, mouse status LEDs, printer status LEDs, and the like), which are generally configured to provide a status for any component of the computing system.

The computing system 102 may include a housing (not shown), and one or more of the user input devices 104, display devices, and/or status devices may be housed within the housing. For example, in one embodiment, the computing system 102 may comprise a laptop computer including a housing that houses a keyboard and a mouse pad or knob, but the housing may house other combinations of any suitable input devices. Of course, the user input devices 104, display devices, and/or status devices need not be housed within a housing of the computing system 102 and may be spaced apart from the housing. Further, the computing system 102 does not require any user input devices 104, display devices, or status devices—depending on the particular configuration of the computing system 102.

As shown in FIG. 1, an automation system 100 may comprise a lighting system. The lighting system may include lighting 106, which provides artificial light. As used herein, the term “lighting” is a broad term and is used in its ordinary meaning and thus includes, but is not limited to, lamps, light fixtures, track lighting, recessed lighting, landscaping lighting, interior decorative lighting, exterior lightings, area lighting, and the like. However, as used herein, the term “lighting” does not include devices that are conventionally configured to provide a visual output of the computing system (such as monitors, touch-sensitive screens, and other display devices)—even though such devices may emit artificial light. Also, as used herein, the term “lighting” does not include devices that are conventionally configured to provide a status for a component of the computing system (such as hard drive LEDs, on-off switch LEDs, mouse status LEDs, printer status LEDs, and other status devices)—even though such devices may emit artificial light.

The lighting 106 may include one or more light bulbs (not shown)—such as fluorescent light bulbs or incandescent light bulbs. In some embodiments, the lighting 106 may be configured to permit replacement of the light bulbs. It will be appreciated, however, that the lighting 106 does not require replaceable light bulbs or any light bulbs, depending on the particular configuration of the lighting.

### Automation Based on User Input

As shown in FIG. 1, the automation system 100 may include an automation module 108. All or at least a portion of the automation module 108 may be embodied within the computing system 102; however, all or at least a portion of the automation module 108 may be embodied outside of the computing system 102, within the computing system 102, in any other suitable location, or any combination of one or more thereof. The automation module 108 may be configured to monitor user input received via the user input devices 104 of the computing system 102, to determine whether threshold user input has been detected, to turn on or otherwise brighten the lighting 106, to turn off or otherwise darken the lighting 106, or any combination of one or more thereof. For example, in one embodiment, the automation module 108 may be configured to turn on or turn off the lighting 106 in response to monitoring the user input and/or in response to determining whether threshold user input has been detected.

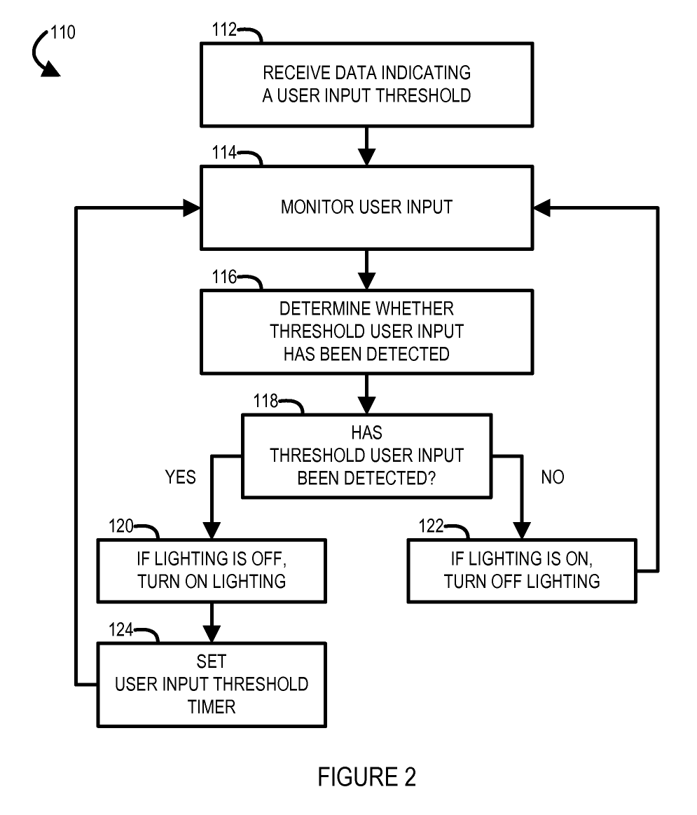

As shown in FIG. 2, the automation module 108 preferably may perform some or all of an automation method 110; however, some or all of the method 110 may be performed by the automation module 108; the computing system 102; the automation system 100; one or more other suitable modules, systems, and the like; or any suitable combination of one or more thereof. Of course, the entire method 110 need not be performed; and any part or parts of the method 110 may be performed to provide a useful method 110.

As shown in FIG. 2, at a block 112, the automation module 108 may receive data indicating a user input threshold. However, the embodiments of the present invention do not require data indicating a user input threshold or any other data to be received. Thus, the method 110 does not require the block 112.

As shown in FIG. 2, at a block 114, the automation module 108 may monitor user input received via at least one of the user input devices 104 of the computing system 102. For example, in one embodiment, the automation module 108 may monitor some, all, one, two, or more of the user input devices 104 to detect the user input (if any) the computing system 102 receives via the monitored user input devices 104.

At a block 116, the automation module 108 may determine whether threshold user input been detected. For example, in one embodiment, a threshold may include one or more parameters used to test or otherwise evaluate the user input (if any) detected at the block 114; and threshold user input may be the user input detected at the block 114 that meets the threshold as defined by the one or more parameters. In a further embodiment, the data indicating a user input threshold received at the block 112 may define or indicate the one or more parameters used to test or otherwise evaluate the user input. However, threshold user input need not be defined by any parameters; and the automation module 108 does not require any parameters to determine whether threshold user input has been detected. For example, in one embodiment, the threshold may establish that any type of (and/or any amount of) user input that the computing system 102 receives via at least one user input device 104 will meet the threshold; thus, no parameters are required because mere detection of user input being received is sufficient to determine that the threshold user input has been detected.

At a block 118, if threshold user input has been detected, the automation module 108 may proceed to a block 120. At the block 120, the automation module 108 may “turn on” or otherwise brighten the lighting 106 and may return to the block 114 to continue monitoring the user input. In one embodiment, at the block 120, if the lighting 106 is “off” or otherwise not brightened, the automation module 108 may “turn on” or otherwise brighten the lighting 106. In one embodiment, at the block 120, if the lighting 106 is “on” or otherwise brightened, the automation module 108 may allow the lighting 106 to remain “on” or otherwise brightened.

When the automation module 108 brightens the lighting 106 at the block 120, the automation module 108 may completely brighten the lighting 106 or at least partially brighten the lighting 106. For example, the lighting 106 may provide varying levels of brightness, and the automation module 108 may be configured to adjust the level of brightness that the lighting 106 provides.

In one embodiment, at the block 120, the automation module 108 may further brighten the lighting 106, for example, when the lighting 106 is already at least partially brightened. Accordingly, the lighting 106 need not be completely darkened in order to be brightened at the block 120. However, the lighting 106 may be completely darkened prior to being brightened at the block 120, if desired.

At the block 118, if threshold user input has not been detected, the automation module 108 may proceed to a block 122. At the block 122, the automation module 108 may “turn off” or otherwise darken the lighting 106 and may return to the block 114 to continue monitoring the user input. In one embodiment, at the block 122, the automation module 108 may “turn off” or otherwise darken the lighting 106 if the lighting 106 is “on” or otherwise brightened. In one embodiment, at the block 122, if the lighting 106 is “off” or otherwise not brightened, the automation module 108 may allow the lighting 106 to remain “off” or otherwise not brightened. When the automation module 108 darkens the lighting 106 at the block 122, the automation module 108 may completely darken the lighting 106 or at least partially darken the lighting 106. Accordingly, after the block 122, the lighting 106 may be completely darkened, but need not be completely darkened.

In one embodiment, the automation module 108 may brighten or darken the lighting 106 by altering an amount of electricity provided to the lighting 106. For example, to brighten the lighting 106, the automation module 108 may provide an amount of electricity to the lighting 106—such as an initial amount of electricity or an increased amount of electricity. Also, for example, to darken the lighting 106, the automation module 108 may decrease an amount of electricity provided to the lighting 106 or may withdraw the electricity provided to the lighting 106.

In one embodiment, the automation module 108 may use a user input threshold timer to keep the lighting 106 “on” or otherwise brightened for an associated time period. For example, as shown in FIG. 2, the automation module 108 may proceed from the block 120 to a block 124, may set or reset a user input threshold timer at the block 124, and may return to the block 114 to continue monitoring the user input. After proceeding from the block 124 to the block 114, the automation module 108 may, at the block 116, determine whether threshold user input has been detected within the user input threshold time period. If, at the block 118, threshold user input has been detected within the user input threshold time period, the automation module 108 may proceed to the block 120. If, at the block 118, threshold user input has not been detected within the user input threshold time period, the automation module 108 may proceed to the block 122. Of course, the automation system 100 does not require any user input threshold timer, and the automation module 108 may return from the block 120 directly to the block 114 to continue monitoring the user input.

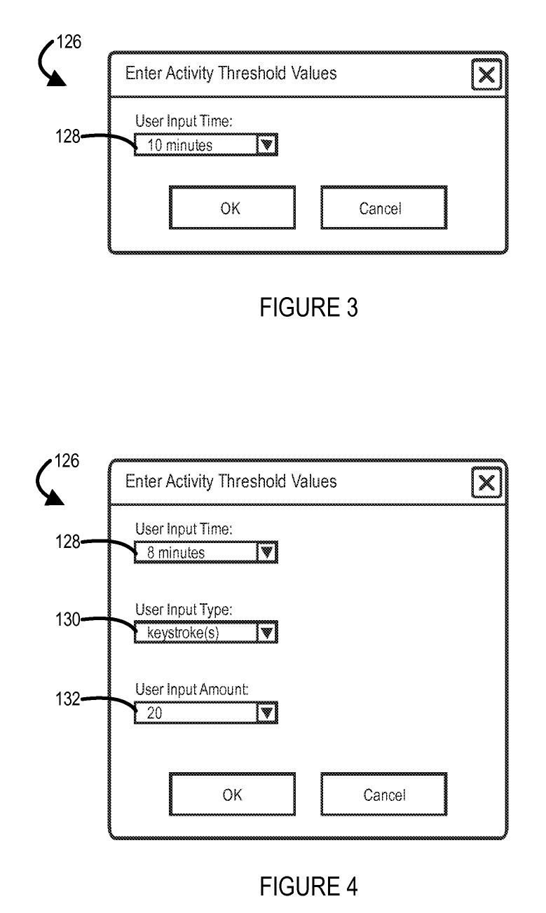

As shown in FIGS. 3, 4, 8, 9, 13 and 14, a user interface 126 may include one or more user interface elements configured to receive data at least partially indicating a user input threshold, a motion threshold, a proximity threshold, any other threshold, other data, or any combination of one or more thereof. For example, the user interface 126 preferably comprises a graphical user interface including one or more graphical user interface elements, such as buttons, pull down menus, dialog boxes, check boxes, radio or option buttons, drop-down list boxes, scroll bars, scroll boxes, text boxes, and the like. Throughout this patent application, various graphical user interfaces and graphical user interface elements are depicted; however, the depicted graphical user interfaces and graphical user interface elements are not necessary to receive any particular data. Indeed, other user interfaces and/or other user interface elements may be configured to receive data described in this patent application. Accordingly, although particular user interfaces with particular user interface elements are depicted in FIGS. 3, 4, 8, 9, 13 and 14, the embodiments of the present invention are not limited to those user interfaces or to those user interface elements. Also, the data at least partially indicating one or more thresholds need not be received via any user interface and may be received via other suitable means. Further, the embodiments of the present invention do not require any data to be received—whether via user interface elements or other means.

As shown in FIG. 3, the user interface 126 may include a drop-down list box 128, which may be configured to receive a time value for a user input threshold. For example, a user may use the drop-down list box 128 to enter a time value for a user input threshold. The time value for a user input threshold need not be user selected, and the automation system 100 does not require any time value for a user input threshold or any user input threshold time period—depending, for example, upon the particular implementation of the user input threshold.

In one embodiment, the time value for a user input threshold may define or indicate a user input threshold time period during which threshold user input preferably must be detected (and/or preferably must not be detected) in order to commence, maintain, and/or cease performing one or more automation actions—such as brightening the lighting 106 at the block 120 in FIG. 2 or darkening the lighting 106 at the block 122 in the FIG. 2. In one embodiment, the time value for a user input threshold may define or indicate a user input threshold time period for which a particular automation action may be maintained after threshold user input has been detected (such as at the block 118 in FIG. 2). In a further embodiment, a user input threshold timer (such as at the timer at the block 124) may be associated with the user input threshold time period.

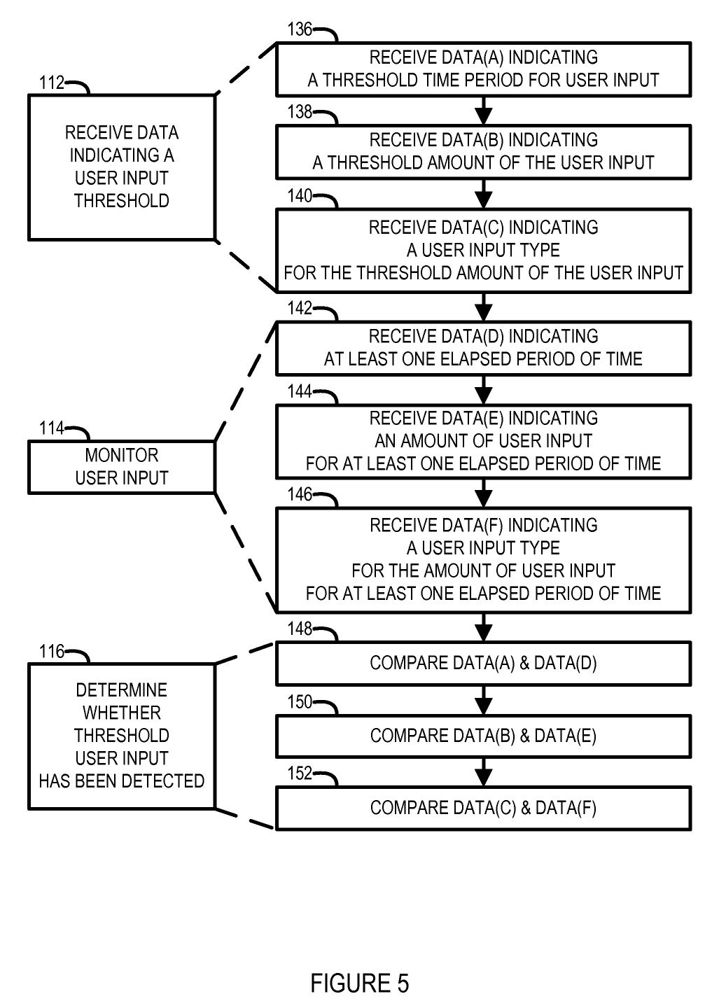

As shown in FIG. 4, the user interface 126 (FIG. 3) may also include at least one drop-down list box 130, which may be configured to receive at least one user input type value for a user input threshold. For example, a user may use the drop-down list box 130 to enter a user input type value for a user input threshold. The user input type value for a user input threshold need not be user selected, and the automation system 100 does not require any user input type value for a user input threshold—depending, for example, upon the particular implementation of the user input threshold.

In one embodiment, the user input type value may define or indicate one or more types of user input that may be monitored (such as at the block 114 in FIG. 2), detected (such as at the block 118 in FIG. 2), or both monitored and detected. In one embodiment, the user input type value may define or indicate one or more types of user input devices via which user input may be monitored, detected, or both monitored and detected. In one embodiment, the user input type value may define or indicate some, all, one, two, or more of the user input devices 104 via which user input may be monitored, detected, or both monitored and detected.

In one embodiment, the user input type value may define or indicate one or more types of user input that preferably must be detected (and/or preferably must not be detected) in order to commence, maintain, and/or cease performing one or more automation actions—such as brightening the lighting 106 at the block 120 in FIG. 2 or darkening the lighting 106 at the block 122 in the FIG. 2. In one embodiment, the user input type value may define or indicate one or more types of user input devices via which user input preferably must be detected (and/or preferably must not be detected) in order to commence, maintain, and/or cease performing one or more automation actions. In one embodiment, the user input type value may define or indicate some, all, one, two, or more of the user input devices 104 via which user input preferably must be detected (and/or preferably must not be detected) in order to commence, maintain, and/or cease performing one or more automation actions.

As shown in FIG. 4, the user interface 126 may also include at least one drop-down list box 132, which may be configured to receive at least one user input amount value for a user input threshold. For example, a user may use the drop-down list box 132 to enter a user input amount value for a user input threshold. The user input amount value for a user input threshold need not be user selected, and the automation system 100 does not require any user input amount value for a user input threshold—depending, for example, upon the particular implementation of the user input threshold.

In one embodiment, the user input amount value may define or indicate a threshold amount of user input to detect (such as at the block 118 in FIG. 2). In one embodiment, the user input amount value may define or indicate a threshold amount of user input that preferably must be detected (and/or preferably must not be detected) in order to commence, maintain, and/or cease performing one or more automation actions—such as brightening the lighting 106 at the block 120 in FIG. 2 or darkening the lighting 106 at the block 122 in the FIG. 2.

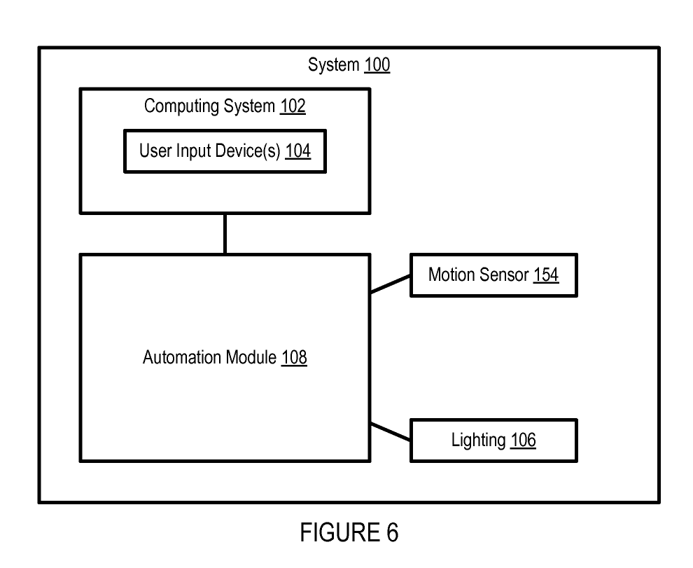

As shown in FIG. 5, in one embodiment, the block 112 of the automation method 110 (FIG. 2) may comprise a block 136, a block 138, a block 140, other processes, or any combination of one or more thereof. In one embodiment, the block 114 of the automation method 110 may comprise a block 142, a block 144, a block 146, other processes, or any combination of one or more thereof. In one embodiment, the block 116 of the automation method 110 may comprise a block 148, a block 150, a block 152, other processes, or any combination of one or more thereof.

As shown in FIG. 5, at the block 136, the automation module 108 may receive Data A indicating a threshold time period for user input. In one embodiment, the automation module 108 may receive the Data A via the drop-down list box 128 (FIGS. 3-4); but the automation module 108 may receive or access the Data A in any other suitable manner. In one embodiment, the Data A may comprise a time value for a user input threshold.

As shown in FIG. 5, at the block 138, the automation module 108 may receive Data B indicating a threshold amount of the user input. In one embodiment, the automation module 108 may receive the Data B via the drop-down list box 132 (FIG. 4); but the automation module 108 may receive or access the Data B in any other suitable manner. In one embodiment, the Data B may comprise a user input amount value for a user input threshold.

As shown in FIG. 5, at the block 140, the automation module 108 may receive Data C indicating a user input type for the threshold amount of the user input. In one embodiment, the automation module 108 may receive the Data C via the drop-down list box 130 (FIG. 4); but the automation module 108 may receive or access the Data C in any other suitable manner. In one embodiment, the Data C may comprise a user input type value for a user input threshold.

As shown in FIG. 5, at the block 142, the automation module 108 may receive Data D indicating at least one elapsed period of time. In one embodiment, the Data D may be received via at least one timer (such as the timer at the block 124 in FIG. 2); however, the Data D may be received or accessed in any other suitable manner.

As shown in FIG. 5, at the block 144, the automation module 108 may receive Data E indicating an amount of user input for the at least one elapsed period of time (block 142). In one embodiment, the Data E may indicate an amount of user input detected during the at least one elapsed period of time. For example, the Data E may indicate that no user input was detected, that at least a specific amount of user input was not detected, that user input was detected, that at least a specific amount of user input was detected, or any combination of one or more thereof.

As shown in FIG. 5, at the block 146, the automation module 108 may receive Data F indicating a user input type for the amount of user input for the at least one elapsed period of time (block 144). In one embodiment, the Data F may indicate a type of user input detected during the at least one elapsed period of time. For example, the Data F may indicate one or more types of user input that was received, one or more types of user input devices via which user input was received, one or more of the user input devices 104 via which user input was received, or any combination of one or more thereof.

As shown in FIG. 5, at the block 148, the automation module 108 may compare or otherwise use the Data A and the Data D to, for example, determine whether a threshold time period for user input has elapsed. At the block 150, the automation module 108 may compare or otherwise use the Data B and the Data E to, for example, determine whether a threshold amount of user input was received. At the block 152, the automation module 108 may compare or otherwise use the Data C and that Data F to, for example, determine whether a threshold type of user input was received.

### Automation Based on User Input/Motion

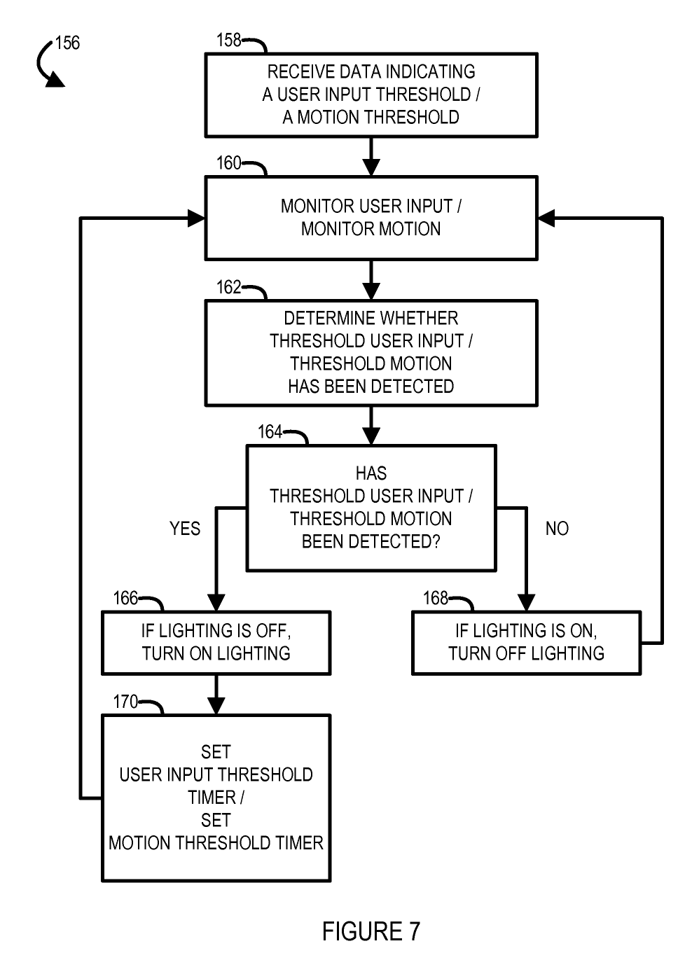

As shown in FIG. 6, the automation system 100 (FIG. 1) may include a motion sensor 154 that is preferably configured to detect motion. The automation module 108 may be configured to monitor user input received via the user input devices 104 of the computing system 102, to monitor motion detected by the motion sensor 154, to determine whether threshold user input has been detected, to determine whether threshold motion has been detected, to turn on or otherwise brighten the lighting 106, to turn off or otherwise darken the lighting 106, or any combination of one or more thereof. For example, in one embodiment, the automation module 108 may be configured to turn on or turn off the lighting 106 in response to monitoring the user input and the motion and/or in response to determining whether threshold user input and threshold motion has been detected. Also, for example, in one embodiment, the automation module 108 may be configured to turn on or turn off the lighting 106 in response to monitoring the motion and/or in response to determining whether threshold motion has been detected.

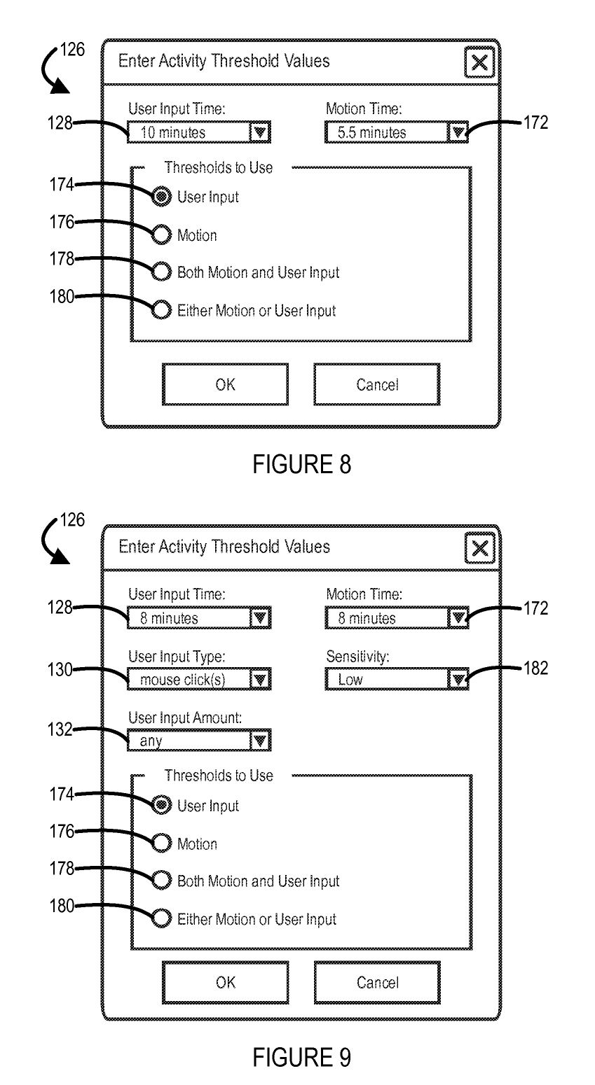

As shown in FIG. 7, the automation module 108 preferably may perform some or all of an automation method 156; however, some or all of the method 156 may be performed by the automation module 108; the computing system 102; the automation system 100; one or more other suitable modules, systems, and the like; or any suitable combination of one or more thereof. Of course, the entire method 156 need not be performed; and any part or parts of the method 156 may be performed to provide a useful method 156.

As shown in FIG. 7, at a block 158, the automation module 108 may receive data indicating a user input threshold and/or data indicating a motion threshold. However, the embodiments of the present invention do not require data indicating a user input threshold, data indicating a motion threshold, or any other data to be received. Thus, the method 156 does not require the block 158.

As shown in FIG. 7, at a block 160, the automation module 108 may monitor user input received via at least one of the user input devices 104 of the computing system 102, may monitor motion detected by the motion sensor 154, or both. For example, in one embodiment, the automation module 108 may monitor the motion (if any) detected by the motion sensor 154.

At a block 162, the automation module 108 may determine whether threshold user input been detected and/or whether threshold motion has been detected. In one embodiment, a threshold may include one or more parameters used to test or otherwise evaluate the motion (if any) detected at the block 160; and threshold motion may be the motion detected at the block 160 that meets the threshold as defined by the one or more parameters. In a further embodiment, the data indicating a motion threshold received at the block 158 may define or indicate the one or more parameters used to test or otherwise evaluate the motion. However, threshold motion need not be defined by any parameters; and the automation module 108 does not require any parameters to determine whether threshold motion has been detected. For example, in one embodiment, the threshold may establish that any type of (and/or any amount of) motion that the motion sensor 154 detects will meet the threshold; thus, no parameters are required because mere detection of motion is sufficient to determine that the threshold motion has been detected.

In one embodiment, at a block 164, if threshold user input has been detected and if threshold motion has been detected, the automation module 108 may proceed to a block 166. In this embodiment, at the block 164, if threshold user input has not been detected or if threshold motion has not been detected, the automation module 108 may proceed to a block 168.

In one embodiment, at the block 164, if threshold user input has been detected or if threshold motion has been detected, the automation module 108 may proceed to a block 166. In this embodiment, at the block 164, if threshold user input has not been detected and if threshold motion has not been detected, the automation module 108 may proceed to a block 168.

At the block 166, the automation module 108 may “turn on” or otherwise brighten the lighting 106 and may return to the block 160 to continue monitoring the user input, the motion, or both. In one embodiment, at the block 166, if the lighting 106 is “off” or otherwise not brightened, the automation module 108 may “turn on” or otherwise brighten the lighting 106. In one embodiment, at the block 166, if the lighting 106 is “on” or otherwise brightened, the automation module 108 may allow the lighting 106 to remain “on” or otherwise brightened.

When the automation module 108 brightens the lighting 106 at the block 166, the automation module 108 may completely brighten the lighting 106 or at least partially brighten the lighting 106. For example, the lighting 106 may provide varying levels of brightness, and the automation module 108 may be configured to adjust the level of brightness that the lighting 106 provides.

In one embodiment, at the block 166, the automation module 108 may further brighten the lighting 106, for example, when the lighting 106 is already at least partially brightened. Accordingly, the lighting 106 need not be completely darkened in order to be brightened at the block 166. However, the lighting 106 may be completely darkened prior to being brightened at the block 166, if desired.

At the block 168, the automation module 108 may “turn off” or otherwise darken the lighting 106 and may return to the block 160 to continue monitoring the user input, the motion, or both. In one embodiment, at the block 168, the automation module 108 may “turn off” or otherwise darken the lighting 106 if the lighting 106 is “on” or otherwise brightened. In one embodiment, at the block 168, if the lighting 106 is “off” or otherwise not brightened, the automation module 108 may allow the lighting 106 to remain “off” or otherwise not brightened. When the automation module 108 darkens the lighting 106 at the block 168, the automation module 108 may completely darken the lighting 106 or at least partially darken the lighting 106. Accordingly, after the block 168, the lighting 106 may be completely darkened, but need not be completely darkened.

In one embodiment, the automation module 108 may use a user input threshold timer and/or a motion threshold timer to keep the lighting 106 “on” or otherwise brightened for an associated time period. For example, as shown in FIG. 7, the automation module 108 may proceed from the block 166 to a block 170; may set or reset a user input threshold timer and/or may set or reset a motion threshold timer at the block 170; and may return to the block 160 to continue monitoring the user input, the motion, or both. After proceeding from the block 170 to the block 160, the automation module 108 may, at the block 162, determine whether threshold user input has been detected within the user input threshold time period, whether threshold motion has been detected within the motion threshold time period, or both. In a first further embodiment, if, at the block 164, either threshold user input has been detected within the user input threshold time period or threshold motion has been detected within the motion threshold time period, the automation module 108 may proceed to the block 166. In this first further embodiment, if, at the block 164, threshold user input has not been detected within the user input threshold time period and threshold motion has not been detected within the motion threshold time period, the automation module 108 may proceed to the block 168. In a second further embodiment, if, at the block 164, threshold user input has been detected within the user input threshold time period and threshold motion has been detected within the motion threshold time period, the automation module 108 may proceed to the block 166. In this second further embodiment, if, at the block 164, either threshold user input has not been detected within the user input threshold time period or threshold motion has not been detected within the motion threshold time period, the automation module 108 may proceed to the block 168.

In one embodiment, a single timer may be used to provide a single time period for the user input and for the motion—if desired. However, any number of one or more user input threshold timers and/or one or more motion threshold timers may be used; and the user input threshold timers and/or the motion threshold timers may define the same, similar, or entirely different time periods. Of course, the automation system 100 does not require any user input threshold timers or any motion threshold timers, and the automation module 108 may return from the block 166 directly to the block 160 to continue monitoring the user input, the motion, or both.

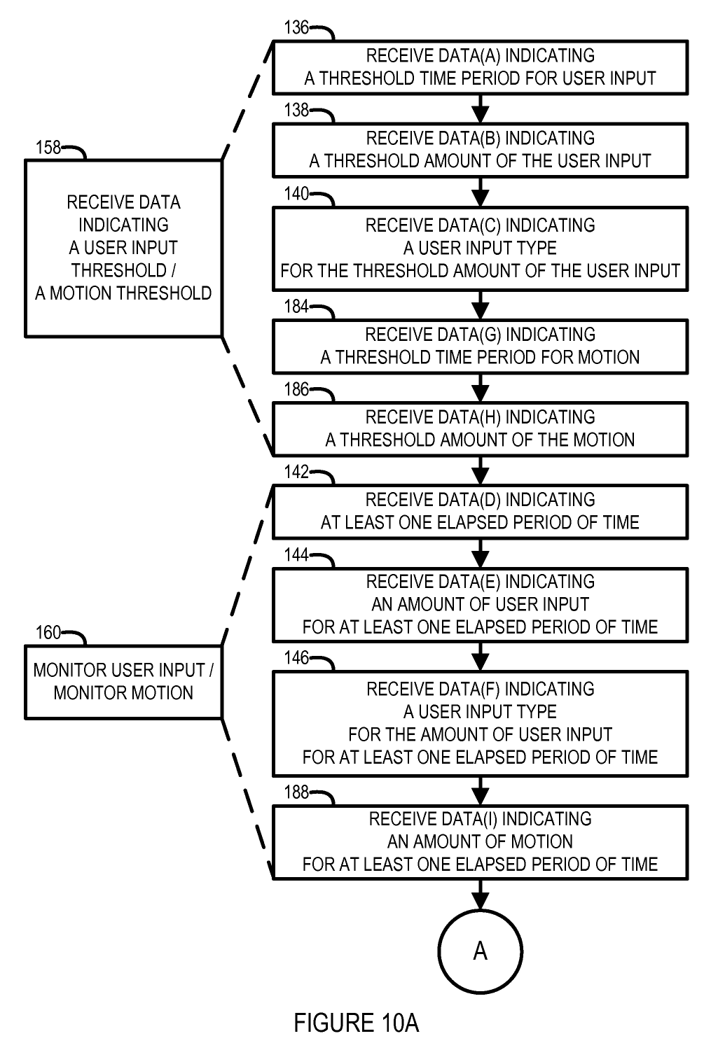

As shown in FIG. 8, the user interface 126 may also include a drop-down list box 172, which may be configured to receive a time value for a motion threshold. For example, a user may use the drop-down list box 172 to enter a time value for a motion threshold. The time value for a motion threshold need not be user selected, and the automation system 100 does not require any time value for a motion threshold or any motion threshold time period—depending, for example, upon the particular implementation of the motion threshold.

In one embodiment, the time value for a motion threshold may define or indicate a motion threshold time period during which threshold motion preferably must be detected (and/or preferably must not be detected) in order to commence, maintain, and/or cease performing one or more automation actions—such as brightening the lighting 106 at the block 166 in FIG. 7 or darkening the lighting 106 at the block 168 in the FIG. 7. In one embodiment, the time value for a motion threshold may define or indicate a motion threshold time period for which a particular automation action may be maintained after threshold motion has been detected (such as at the block 162 in FIG. 7). In a further embodiment, a motion threshold timer (such as at the timer at the block 170) may be associated with the motion threshold time period.

As shown in FIG. 8, the user interface 126 may include one or more user interface elements preferably configured to receive a threshold selection—such as one or more radio buttons 174, 176, 178, and 180. In one embodiment, a user may use the radio buttons 174, 176, 178, and 180 to select one or more thresholds the automation module 108 may use to, for example, determine whether to commence, maintain, and/or cease performance of one or more automation actions, such as brightening or darkening the lighting 106. A single threshold may be selected using the radio buttons 174, 176, 178, and 180; however, any other combination of one or more of the thresholds may be selected using the radio buttons 174, 176, 178, and 180—if desired.

In greater detail, by selecting the radio button 174, the automation module 108 may “turn on” or otherwise brighten (or keep “on” or brightened) the lighting 106 in response to detecting threshold user input; and may “turn off” or otherwise darken (or keep “off” or darkened) the lighting 106 in response to failing to detect threshold user input. By selecting the radio button 176, the automation module 108 may “turn on” or otherwise brighten (or keep “on” or brightened) the lighting 106 in response to detecting threshold motion; and may “turn off” or otherwise darken (or keep “off” or darkened) the lighting 106 in response to failing to detect threshold motion. By selecting the radio button 178, the automation module 108 may “turn on” or otherwise brighten (or keep “on” or brightened) the lighting 106 in response to detecting both threshold motion and threshold user input; and may “turn off” or otherwise darken (or keep “off” or darkened) the lighting 106 in response to failing to detect either threshold motion or threshold user input. By selecting the radio button 180, the automation module 108 may “turn on” or otherwise brighten (or keep “on” or brightened) the lighting 106 in response to detecting either threshold motion or threshold user input; and “turn off” or otherwise darken (or keep “off” or darkened) the lighting 106 in response to failing to detect both threshold motion and threshold user input.

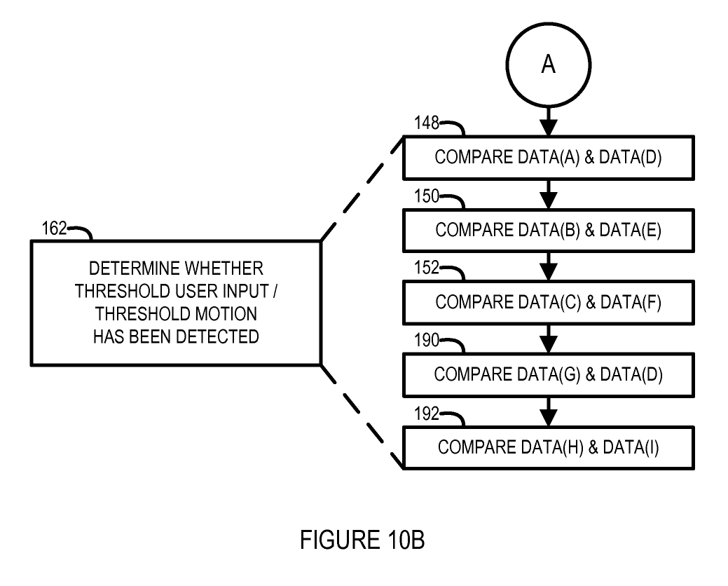

As shown in FIG. 9, the user interface 126 may also include a drop-down list box 182, which may be configured to receive a motion sensitivity value for a motion threshold. For example, a user may use the drop-down list box 182 to enter a motion sensitivity value for a motion threshold. The motion sensitivity value for a motion threshold need not be user selected, and the automation system 100 does not require any motion sensitivity value for a motion threshold—depending, for example, upon the particular implementation of the motion threshold.

In one embodiment, the motion sensitivity value may define or indicate a threshold amount of motion to detect (such as at the block 162 in FIG. 7). In one embodiment, the motion sensitivity value may define or indicate a threshold amount of motion that preferably must be detected (and/or preferably must not be detected) in order to commence, maintain, and/or cease performing one or more automation actions—such as brightening the lighting 106 at the block 166 in FIG. 7 or darkening the lighting 106 at the block 168 in the FIG. 7.

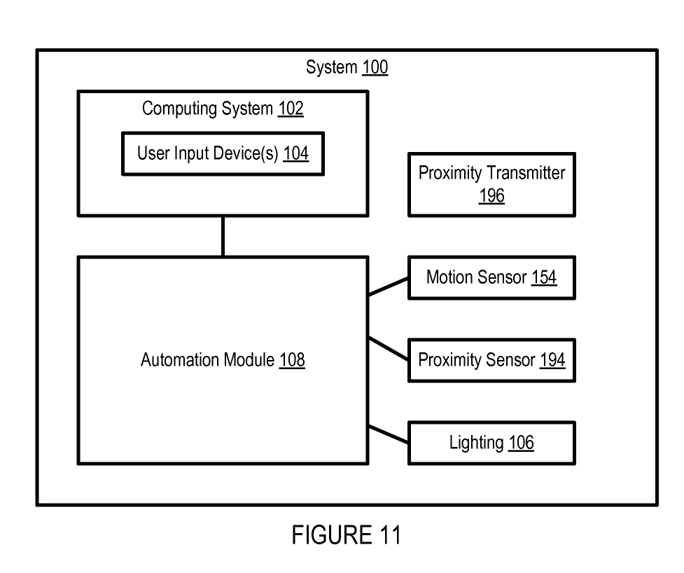

As shown in FIGS. 10A and 10B, in one embodiment, the block 158 of the automation method 156 (FIG. 7) may comprise a block 136, a block 138, a block 140, a block 184, a block 186, other processes, or any combination of one or more thereof. In one embodiment, the block 160 of the automation method 156 may comprise a block 142, a block 144, a block 146, a block 188, other processes, or any combination of one or more thereof. In one embodiment, the block 162 of the automation method 156 may comprise a block 148, a block 150, a block 152, a block 190, a block 192, other processes, or any combination of one or more thereof.

As shown in FIG. 10A, at the block 136, the automation module 108 may receive Data A indicating a threshold time period for user input, for example, as described above with reference to FIG. 5. At the block 138, the automation module 108 may receive Data B indicating a threshold amount of the user input, for example, as described above with reference to FIG. 5. At the block 140, the automation module 108 may receive Data C indicating a user input type for the threshold amount of the user input, for example, as described above with reference to FIG. 5.

As shown in FIG. 10A, at the block 184, the automation module 108 may receive Data G indicating a threshold time period for motion. In one embodiment, the automation module 108 may receive the Data G via the drop-down list box 172 (FIGS. 8-9); but the automation module 108 may receive or access the Data G in any other suitable manner. In one embodiment, the Data G may comprise a time value for a motion threshold.

As shown in FIG. 10A, at the block 186, the automation module 108 may receive Data H indicating a threshold amount of the motion. In one embodiment, the automation module 108 may receive the Data H via the drop-down list box 182 (FIG. 9); but the automation module 108 may receive or access the Data H in any other suitable manner. In one embodiment, the Data H may comprise a motion sensitivity value for a motion threshold.

As shown in FIG. 10A, at the block 142, the automation module 108 may receive Data D indicating at least one elapsed period of time, for example, as described above with reference to FIG. 5. At the block 144, the automation module 108 may receive Data E indicating an amount of user input for the at least one elapsed period of time, for example, as described above with reference to FIG. 5. At the block 146, the automation module 108 may receive Data F indicating a user input type for the amount of user input for the at least one elapsed period of time, for example, as described above with reference to FIG. 5.

As shown in FIG. 10A, at the block 188, the automation module 108 may receive Data I indicating an amount of motion for the at least one elapsed period of time (block 142). In one embodiment, the Data I may indicate an amount of motion detected during the at least one period of time. For example, the Data I may indicate that no motion was detected, that at least a specific amount of motion was not detected, that motion was detected, that at least a specific amount of motion was detected, or any combination of one or more thereof.

As shown in FIG. 10B, at the block 148, the automation module 108 may compare or otherwise use the Data A and the Data D to, for example, determine whether a threshold time period for user input has elapsed. At the block 150, the automation module 108 may compare or otherwise use the Data B and the Data E to, for example, determine whether a threshold amount of user input was received. At the block 152, the automation module 108 may compare or otherwise use the Data C and that Data F to, for example, determine whether a threshold type of user input was received. At the block 190, the automation module 108 may compare or otherwise use the Data G and the Data D to, for example, determine whether a threshold time period for motion has elapsed. At the block 192, the automation module 108 may compare or otherwise use the Data H and the Data I to, for example, determine whether a threshold amount of motion was detected.

### Automation Based on User Input/Motion/Proximity

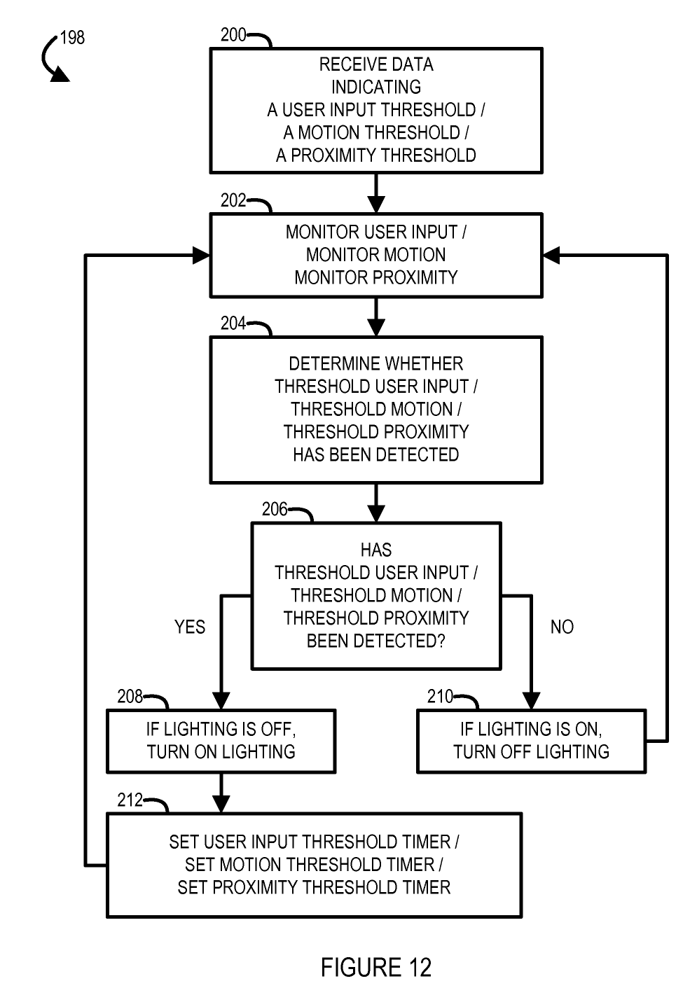

As shown in FIG. 11, the automation system 100 may include a proximity sensor 194 that is preferably configured to detect the proximity of one or more proximity transmitters 196. The automation module 108 may be configured to monitor user input received via the user input devices 104 of the computing system 102, to monitor motion detected by the motion sensor 154, to monitor proximity detected by the proximity sensor 194, to determine whether threshold user input has been detected, to determine whether threshold motion has been detected, to determine whether threshold proximity has been detected, to turn on or otherwise brighten the lighting 106, to turn off or otherwise darken the lighting 106, or any combination of one or more thereof. For example, in one embodiment, the automation module 108 may be configured to turn on or turn off the lighting 106 in response to monitoring the user input, the motion, and the proximity; and/or in response to determining whether threshold user input, threshold motion, and threshold motion has been detected. Also, for example, in one embodiment, the automation module 108 may be configured to turn on or turn off the lighting 106 in response to monitoring the proximity and/or in response to determining whether threshold proximity has been detected.

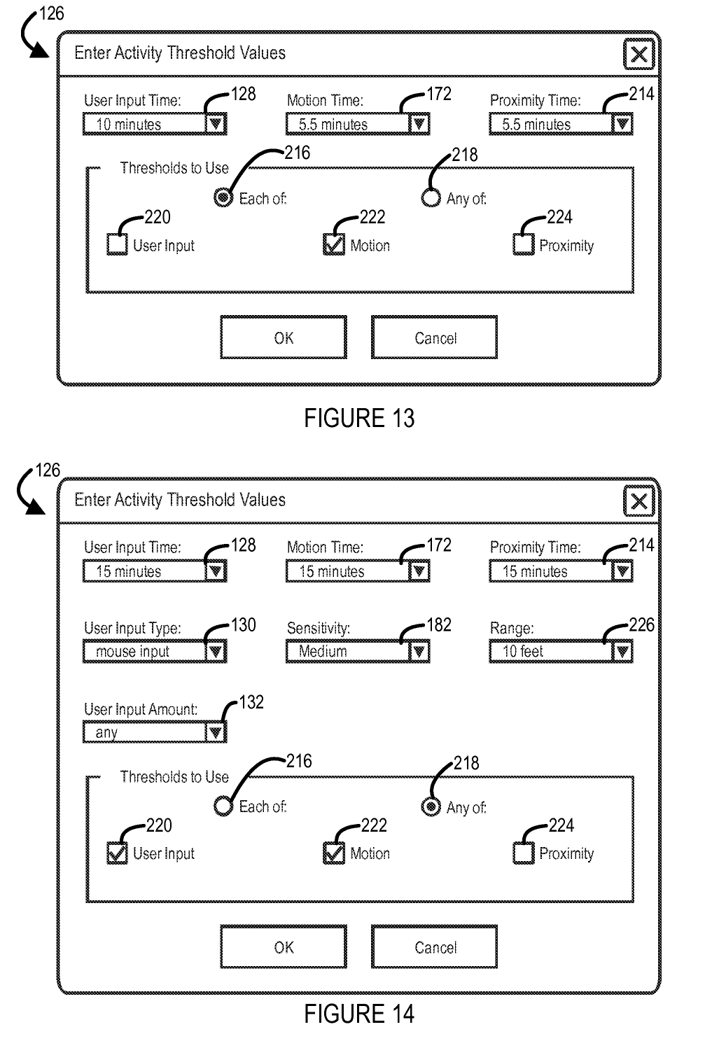

As shown in FIG. 12, the automation module 108 preferably may perform some or all of an automation method 198; however, some or all of the method 198 may be performed by the automation module 108; the computing system 102; the automation system 100; one or more other suitable modules, systems, and the like; or any suitable combination of one or more thereof. Of course, the entire method 198 need not be performed; and any part or parts of the method 198 may be performed to provide a useful method 198.

As shown in FIG. 12, at a block 200, the automation module 108 may receive data indicating a user input threshold, data indicating a motion threshold, data indicating a proximity threshold, or any combination of one or more thereof. However, the embodiments of the present invention do not require data indicating a user input threshold, data indicating a motion threshold, data indicating a proximity threshold, or any other data to be received. Thus, the method 198 does not require the block 200.

As shown in FIG. 12, at a block 202, the automation module 108 may monitor user input received via at least one of the user input devices 104 of the computing system 102, may monitor motion detected by the motion sensor 154, may monitor proximity detected by the proximity sensor 194, or any combination of one or more thereof. For example, in one embodiment, the automation module 108 may monitor the proximity (if any) detected by the proximity sensor 194.

At a block 204, the automation module 108 may determine whether threshold user input been detected, whether threshold motion has been detected, whether threshold proximity has been detected, or any combination of one or more thereof. In one embodiment, a threshold may include one or more parameters used to test or otherwise evaluate the proximity (if any) detected at the block 204; and threshold proximity may be the proximity detected at the block 204 that meets the threshold as defined by the one or more parameters. In a further embodiment, the data indicating a proximity threshold received at the block 200 may define or indicate the one or more parameters used to test or otherwise evaluate the proximity. However, threshold proximity need not be defined by any parameters; and the automation module 108 does not require any parameters to determine whether threshold proximity has been detected. For example, in one embodiment, the threshold may establish that any type of (and/or any amount of) proximity that the proximity sensor 194 detects will meet the threshold; thus, no parameters are required because mere detection of proximity is sufficient to determine that the threshold proximity has been detected.

In one embodiment, at the block 206, if threshold user input has been detected and if threshold motion has been detected and if threshold proximity has been detected, the automation module 108 may proceed to a block 208. In this embodiment, at the block 206, if threshold user input has not been detected or if threshold motion has not been detected or if threshold proximity has not been detected, the automation module 108 may proceed to a block 210.

In one embodiment, at the block 206, if threshold user input has been detected or if threshold motion has been detected or if threshold proximity has been detected, the automation module 108 may proceed to a block 208. In this embodiment, at the block 206, if threshold user input has not been detected and if threshold motion has not been detected and if threshold proximity has not been detected, the automation module 108 may proceed to a block 210.

At the block 208, the automation module 108 may “turn on” or otherwise brighten the lighting 106 and may return to the block 202 to continue monitoring the user input, the motion, the proximity, or any combination of one or more thereof. In one embodiment, at the block 208, if the lighting 106 is “off” or otherwise not brightened, the automation module 108 may “turn on” or otherwise brighten the lighting 106. In one embodiment, at the block 208, if the lighting 106 is “on” or otherwise brightened, the automation module 108 may allow the lighting 106 to remain “on” or otherwise brightened.

When the automation module 108 brightens the lighting 106 at the block 208, the automation module 108 may completely brighten the lighting 106 or at least partially brighten the lighting 106. For example, the lighting 106 may provide varying levels of brightness, and the automation module 108 may be configured to adjust the level of brightness that the lighting 106 provides.

In one embodiment, at the block 208, the automation module 108 may further brighten the lighting 106, for example, when the lighting 106 is already at least partially brightened. Accordingly, the lighting 106 need not be completely darkened in order to be brightened at the block 208. However, the lighting 106 may be completely darkened prior to being brightened at the block 208, if desired.

At the block 210, the automation module 108 may “turn off” or otherwise darken the lighting 106 and may return to the block 202 to continue monitoring the user input, the motion, the proximity, or any combination of one or more thereof. In one embodiment, at the block 210, the automation module 108 may “turn off” or otherwise darken the lighting 106 if the lighting 106 is “on” or otherwise brightened. In one embodiment, at the block 210, if the lighting 106 is “off” or otherwise not brightened, the automation module 108 may allow the lighting 106 to remain “off” or otherwise not brightened. When the automation module 108 darkens the lighting 106 at the block 210, the automation module 108 may completely darken the lighting 106 or at least partially darken the lighting 106. Accordingly, after the block 210, the lighting 106 may be completely darkened, but need not be completely darkened.

In one embodiment, the automation module 108 may use a user input threshold timer, a motion threshold timer, a proximity threshold timer, or any combination of one or more thereof to keep the lighting 106 “on” or otherwise brightened for an associated time period. For example, as shown in FIG. 12, the automation module 108 may proceed from the block 208 to a block 212; may set or reset a user input threshold timer, a motion threshold timer, a proximity threshold timer, or any combination of one or more thereof, at the block 212; and may return to the block 202 to continue monitoring the user input, the motion, the proximity, or any combination of one or more thereof. After proceeding from the block 212 to the block 202, the automation module 108 may, at the block 204, determine whether threshold user input has been detected within the user input threshold time period, whether threshold motion has been detected within the motion threshold time period, whether threshold proximity has been detected within the proximity threshold time period, or any combination of one or more thereof. In a first further embodiment, if, at the block 204, threshold user input has been detected within the user input threshold time period or threshold motion has been detected within the motion threshold time period or threshold proximity has been detected within the proximity threshold time period, the automation module 108 may proceed to the block 208. In this first further embodiment, if, at the block 204, threshold user input has not been detected within the user input threshold time period and threshold motion has not been detected within the motion threshold time period and threshold proximity has not been detected within the proximity threshold time period, the automation module 108 may proceed to the block 210. In a second further embodiment, if, at the block 204, threshold user input has been detected within the user input threshold time period and threshold motion has been detected within the motion threshold time period and threshold proximity has been detected within the proximity threshold time period, the automation module 108 may proceed to the block 208. In this second further embodiment, if, at the block 204, threshold user input has not been detected within the user input threshold time period or threshold motion has not been detected within the motion threshold time period or threshold proximity has not been detected within the proximity threshold time period, the automation module 108 may proceed to the block 210.

In one embodiment, a single timer may be used to provide a single time period for the user input, for the motion, and for the proximity—if desired. However, any number of one or more user input threshold timers, one or more motion threshold timers, and one or more proximity threshold timers may be used; and the user input threshold timers, the motion threshold timers, and/or the proximity threshold timers may define the same, similar, or entirely different time periods. Of course, the automation system 100 does not require any user input threshold timers, motion threshold timers, or proximity threshold timers; and the automation module 108 may return from the block 208 directly to the block 202 to continue monitoring the user input, the motion, the proximity, or any combination of one or more thereof.

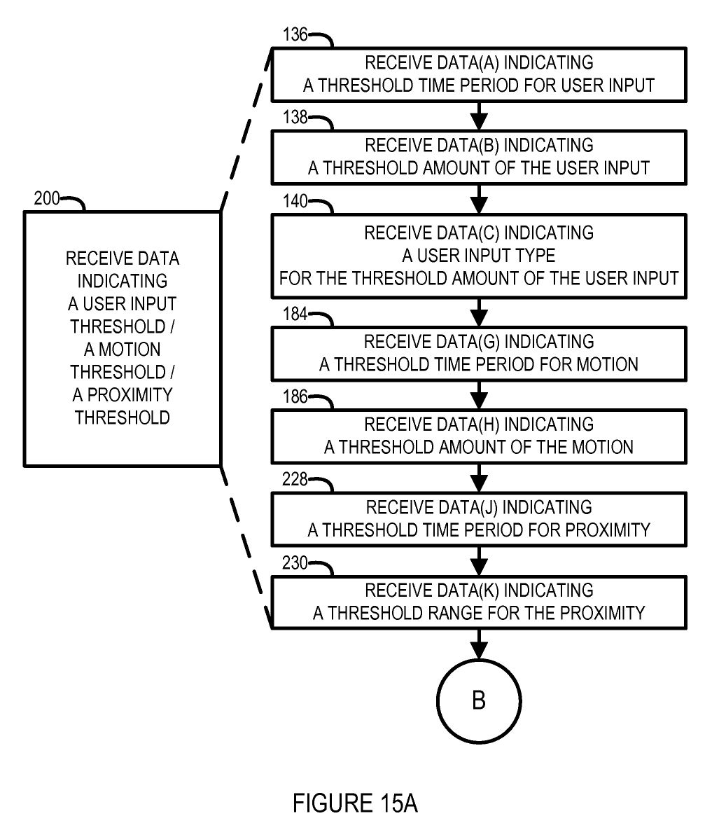

As shown in FIG. 13, the user interface 126 may also include a drop-down list box 214, which may be configured to receive a time value for a proximity threshold. For example, a user may use the drop-down list box 214 to enter a time value for a proximity threshold. The time value for a proximity threshold need not be user selected, and the automation system 100 does not require any time value for a proximity threshold or any proximity threshold time period—depending, for example, upon the particular implementation of the proximity threshold.

In one embodiment, the time value for a proximity threshold may define or indicate a proximity threshold time period during which threshold proximity preferably must be detected (and/or preferably must not be detected) in order to commence, maintain, and/or cease performing one or more automation actions—such as brightening the lighting 106 at the block 208 in FIG. 12 or darkening the lighting 106 at the block 210 in the FIG. 12. In one embodiment, the time value for a proximity threshold may define or indicate a proximity threshold time period for which a particular automation action may be maintained after threshold proximity has been detected (such as at the block 204 in FIG. 12). In a further embodiment, a proximity threshold timer (such as at the timer at the block 212) may be associated with the proximity threshold time period.

As shown in FIG. 13, the user interface 126 may include one or more user interface elements preferably configured to receive a threshold selection—such as one or more radio buttons 216 and 218 and one or more checkboxes 220, 222, and 224. In one embodiment, a user may use the radio buttons 216, 218 and the checkboxes 220, 222, 224 to select one or more thresholds the automation module 108 may use to, for example, determine whether to commence, maintain, and/or cease performance of one or more automation actions—such as brightening or darkening the lighting 106. A single threshold may be selected using the checkboxes 220, 222, and 224; however, any other combination of one or more of the thresholds may be selected using the checkboxes 220, 222, and 224—if desired.

In greater detail, with the radio button 216 selected, the automation module 108 may “turn on” or otherwise brighten (or keep “on” or brightened) the lighting 106 in response to detecting each of the thresholds selected by the checkboxes 220, 222, and 224—which correspond to threshold user input, threshold motion, and threshold proximity respectively. Also, with the radio button 216 selected, the automation module 108 may “turn off” or otherwise darken (or keep “off” or darkened) the lighting 106 in response to not detecting each of the thresholds selected by the checkboxes 220, 222, and 224. In contrast, with the radio button 218 selected, the automation module 108 “turn on” or otherwise brighten (or keep “on” or brightened) the lighting 106 in response to detecting any of the thresholds selected by the checkboxes 220, 222, and 224. Also, with the radio button 216 selected, the automation module 108 may “turn off” or otherwise darken (or keep “off” or darkened) the lighting 106 in response to not detecting any of the thresholds selected by the checkboxes 220, 222, and 224.

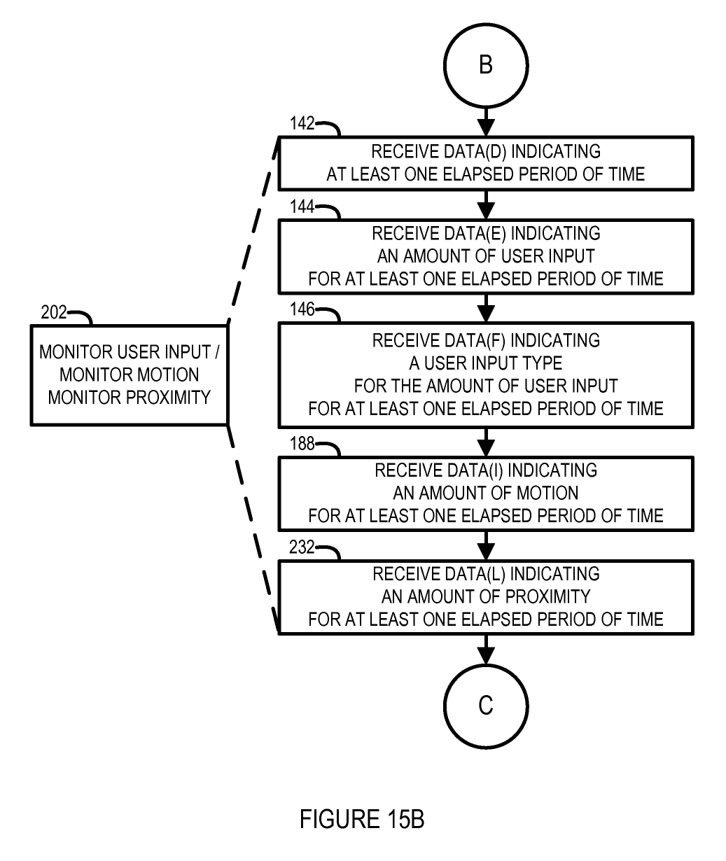

As shown in FIG. 14, the user interface 126 may also include a drop-down list box 226, which may be configured to receive a proximity range value for a proximity threshold. For example, a user may use the drop-down list box 226 to enter a proximity range value for a proximity threshold. The proximity range value for a proximity threshold need not be user selected, and the automation system 100 does not require any proximity range value for a proximity threshold—depending, for example, upon the particular implementation of the proximity threshold.

In one embodiment, the proximity range value may define or indicate a distance, such as the distance between the proximity transmitter 196 (FIG. 11) and the proximity sensor 194 (FIG. 11). In one embodiment, the proximity range value may define or indicate signal strength, such as the strength of the signal transmitted from the proximity transmitter 196 (FIG. 11) and/or received by the proximity sensor 194 (FIG. 11). In one embodiment, the proximity range value may define or indicate a threshold amount of proximity that preferably must be detected (and/or preferably must not be detected) in order to commence, maintain, and/or cease performing one or more automation actions—such as brightening the lighting 106 at the block 208 in FIG. 12 or darkening the lighting 106 at the block 210 in the FIG. 12.

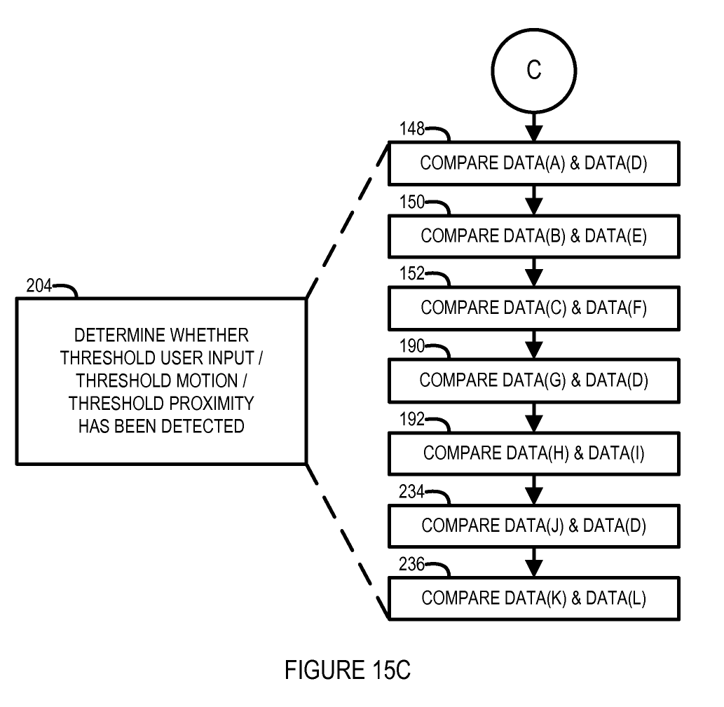

As shown in FIGS. 15A, 15B, and 15C, in one embodiment, the block 200 of the automation method 198 (FIG. 12) may comprise a block 136, a block 138, a block 140, a block 184, a block 186, a block 228, a block 230, other processes, or any combination of one or more thereof. In one embodiment, the block 202 of the automation method 198 may include a block 142, a block 144, a block 146, a block 188, a block 232, other processes, or any combination of one or more thereof. In one embodiment, the block 204 of the automation method 198 may include a block 148, a block 150, a block 152, a block 190, a block 192, a block 234, a block 236, other processes, or any combination of one or more thereof.

As shown in FIG. 15A, at the block 136, the automation module 108 may receive Data A indicating a threshold time period for user input, for example, as described above with reference to FIG. 5. At the block 138, the automation module 108 may receive Data B indicating a threshold amount of the user input, for example, as described above with reference to FIG. 5. At the block 140, the automation module 108 may receive Data C indicating a user input type for the threshold amount of the user input, for example, as described above with reference to FIG. 5. At the block 184, the automation module 108 may receive Data G indicating a threshold time period for motion, for example, as described above with reference to FIG. 10A. At the block 186, the automation module 108 may receive Data H indicating a threshold amount of the motion, for example, as described above with reference to FIG. 10A.

As shown in FIG. 15A, at the block 228, the automation module 108 may receive Data J indicating a threshold time period for proximity. In one embodiment, the automation module 108 may receive the Data J via the drop-down list box 214 (FIGS. 13-14); but the automation module 108 may receive or access the Data J in any other suitable manner. In one embodiment, the Data J may comprise a time value for a proximity threshold.

As shown in FIG. 15A, at the block 230, the automation module 108 may receive Data K indicating a threshold range of the proximity. In one embodiment, the automation module 108 may receive the Data K via the drop-down list box 226 (FIG. 14); but the automation module 108 may receive or access the Data K in any other suitable manner. In one embodiment, the Data K may comprise a proximity range value for a proximity threshold.

As shown in FIG. 15B, at the block 142, the automation module 108 may receive Data D indicating at least one elapsed period of time, for example, as described above with reference to FIG. 5. At the block 144, the automation module 108 may receive Data E indicating an amount of user input for the at least one elapsed period of time, for example, as described above with reference to FIG. 5. At the block 146, the automation module 108 may receive Data F indicating a user input type for the amount of user input for the at least one elapsed period of time, for example, as described above with reference to FIG. 5. At the block 188, the automation module 108 may receive Data I indicating an amount of motion for the at least one elapsed period of time, for example, as described above with reference to FIG. 10A.

As shown in FIG. 15B, at the block 232, the automation module 108 may receive Data L indicating an amount of motion for the at least one elapsed period of time (block 142). In one embodiment, the Data L may indicate an amount of proximity detected during the at least one period of time. For example, the Data L may indicate that no proximity was detected, that at least a specific amount of proximity was not detected, that proximity was detected, that at least a specific amount of proximity was detected, or any combination of one or more thereof.

As shown in FIG. 15C, at the block 148, the automation module 108 may compare or otherwise use the Data A and the Data D to, for example, determine whether a threshold time period for user input has elapsed. At the block 150, the automation module 108 may compare or otherwise use the Data B and the Data E to, for example, determine whether a threshold amount of user input was received. At the block 152, the automation module 108 may compare or otherwise use the Data C and that Data F to, for example, determine whether a threshold type of user input was received. At the block 190, the automation module 108 may compare or otherwise use the Data G and the Data D to, for example, determine whether a threshold time period for motion has elapsed. At the block 192, the automation module 108 may compare or otherwise use the Data H and the Data I to, for example, determine whether a threshold amount of motion was detected. At the block 234, the automation module 108 may compare or otherwise use the Data J and the Data D to, for example, determine whether a threshold time period for proximity has elapsed. At the block 236, the automation module 108 may compare or otherwise use the Data K and the Data L to, for example, determine whether a threshold amount of proximity was detected.

### Automation of Resource Consuming Devices

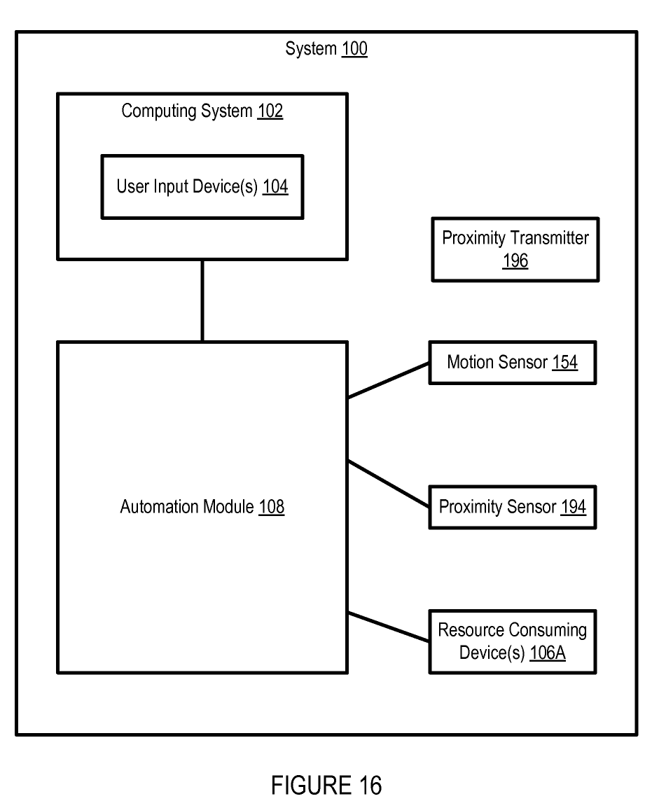

As shown in FIG. 16, the automation system 100 preferably may perform one or more automation actions using one or more resource consuming devices 106A—which may include lighting (such as lighting 106); electronics; appliances; a heating, ventilation, air conditioning (HVAC) system; any other devices that consume energy resources; or any combination of one or more thereof. Exemplary automation actions include, but are not limited to, providing electricity, natural gas, one or more other energy resources, or any combination of one or more thereof to the resource consuming device 106A; withdrawing electricity, natural gas, one or more other energy resources, or any combination of one or more thereof from the resource consuming device 106A; increasing an amount of electricity, natural gas, one or more other energy resources, or any combination of one or more thereof provided to the resource consuming device 106A; decreasing an amount of electricity, natural gas, one or more other energy resources, or any combination of one or more thereof provided to the resource consuming device 106A; activating the resource consuming device 106A; deactivating the resource consuming device 106A; one or more other automation actions; or any combination of one or more thereof.

As discussed above, the automation module 108 of the automation system 100 may use one or more thresholds to determine whether to commence, maintain, and/or cease performance of one or more automation actions. Advantageously, the automation module 108 may perform any number of automation actions using any number resource consuming devices 106A; and the automation actions performed may be the same, similar or entirely different. For example, the automation module 108 of the automation system 100 may be configured to perform a first automation action on a first resource consuming device 106A and to perform a second, different automation action on a second resource consuming device 106A.

The automation module 108 of the automation system 100 may advantageously perform such automation actions help to conserve energy when it is desirable for a resource consuming device 106A to consume less energy when a person is absent. In particular, the automation module 108 may conserve energy resources by, in response to detecting the absence of a person, performing one or more automation actions, such as withdrawing electricity, natural gas, one or more other energy resources, or any combination of one or more thereof from the resource consuming device 106A; decreasing an amount of electricity, natural gas, one or more other energy resources, or any combination of one or more thereof provided to the resource consuming device 106A; deactivating the resource consuming device 106A; or any combination of one or more thereof. In addition, the automation module 108 may, in response to detecting the presence of a person, perform one or more automation actions, such as providing electricity, natural gas, one or more other energy resources, or any combination of one or more thereof to the resource consuming device 106A; increasing an amount of electricity, natural gas, one or more other energy resources, or any combination of one or more thereof provided to the resource consuming device 106A; activating the resource consuming device 106A; or any combination of one or more thereof. In one embodiment, the presence and/or the absence of a person may be detected via detecting threshold user input, threshold motion and/or threshold proximity (discussed above).

In some instances, it may be desirable for the lighting 106 to consume less energy when a person is absent. For example, brightened lighting 106 may waste energy if a person is absent; but, if the person is present, brightened lighting 106 may help the person see better. Accordingly, the automation module 108 of the automation system 100 may advantageously perform one or more automation actions—such as brightening and/or darkening the lighting 106—to conserve energy, if desired.

In some instances, it may be desirable for an HVAC system to consume less energy when a person is absent. Accordingly, in one embodiment, the resource consuming device 106A comprises one or more HVAC systems, and exemplary automation actions include, but are not limited to, triggering the HVAC system to alter the temperature in one or more rooms or other generally enclosed areas; triggering the HVAC system to increase the temperature in one or more rooms or other generally enclosed areas; triggering the HVAC system to decrease the temperature in one or more rooms or other generally enclosed areas; triggering the HVAC system to provide air flow to one or more rooms or other generally enclosed areas; triggering the HVAC system to cease providing air flow to one or more rooms or other generally enclosed areas; triggering the HVAC system to provide heated or cooled air flow to one or more rooms or other generally enclosed areas; triggering the HVAC system to cease providing heated or cooled air flow to one or more rooms or other generally enclosed areas; triggering the HVAC system to provide air flow proximate an entrance to a generally enclosed area (such as the entrance of a store, other high-traffic entrances, or other suitable entrances); triggering the HVAC system to cease providing air flow proximate an entrance to a generally enclosed area; triggering the HVAC system to provide heated or cooled air flow proximate an entrance to a generally enclosed area; triggering the HVAC system to cease providing heated or cooled air flow proximate an entrance to a generally enclosed area; providing electricity, gas, and/or other resource to an HVAC system; withdrawing electricity, gas, and/or other resource from an HVAC system; increasing an amount of electricity, gas, and/or other resource provided to the HVAC system; decreasing an amount of electricity, gas, and/or other resource provided to an HVAC system; activating an HVAC system; deactivating an HVAC system; one or more other automation actions; or any combination of one or more thereof. Advantageously, such automation actions may help to conserve resources by—in response to detecting the presence of a person—increasing or decreasing the temperature. Further, such automation actions may help to conserve resources by—in response to detecting the absence of a person—increasing or decreasing the temperature. In particular, heating, ventilation, and/or cooling may not be desired when a person absent because it may waste resources; however, heating, ventilation, and/or cooling may be desired to provide comfort when a person is present. Accordingly, the automation module 108 of the automation system 100 may automate the heating, ventilation, and/or cooling to conserve resources, if desired. As used herein, a “heating, ventilation, air conditioning (HVAC) system” is category of systems that may provide heating, ventilation, air conditioning, or any combination of one or more thereof. Thus, while some HVAC systems may provide only heating, only ventilation, or only air conditioning, other HVAC systems may provide any combination of two or more of those features.

The automation system 100 may also advantageously perform such automation actions help to conserve energy when it is desirable for a resource consuming device 106A to consume less energy when a person is present. In particular, the automation system 100 may conserve energy resources by, in response to detecting the presence of a person, performing one or more automation actions, such as withdrawing electricity, natural gas, one or more other energy resources, or any combination of one or more thereof from the resource consuming device 106A; decreasing an amount of electricity, natural gas, one or more other energy resources, or any combination of one or more thereof provided to the resource consuming device 106A; deactivating the resource consuming device 106A; or any combination of one or more thereof. In addition, the automation system 100 may, in response to detecting the absence of a person, perform one or more automation actions, such as providing electricity, natural gas, one or more other energy resources, or any combination of one or more thereof to the resource consuming device 106A; increasing an amount of electricity, natural gas, one or more other energy resources, or any combination of one or more thereof provided to the resource consuming device 106A; activating the resource consuming device 106A; or any combination of one or more thereof. In one embodiment, the presence and/or the absence of a person may be detected via detecting threshold user input, threshold motion and/or threshold proximity (discussed above).

### Exemplary Automation Module

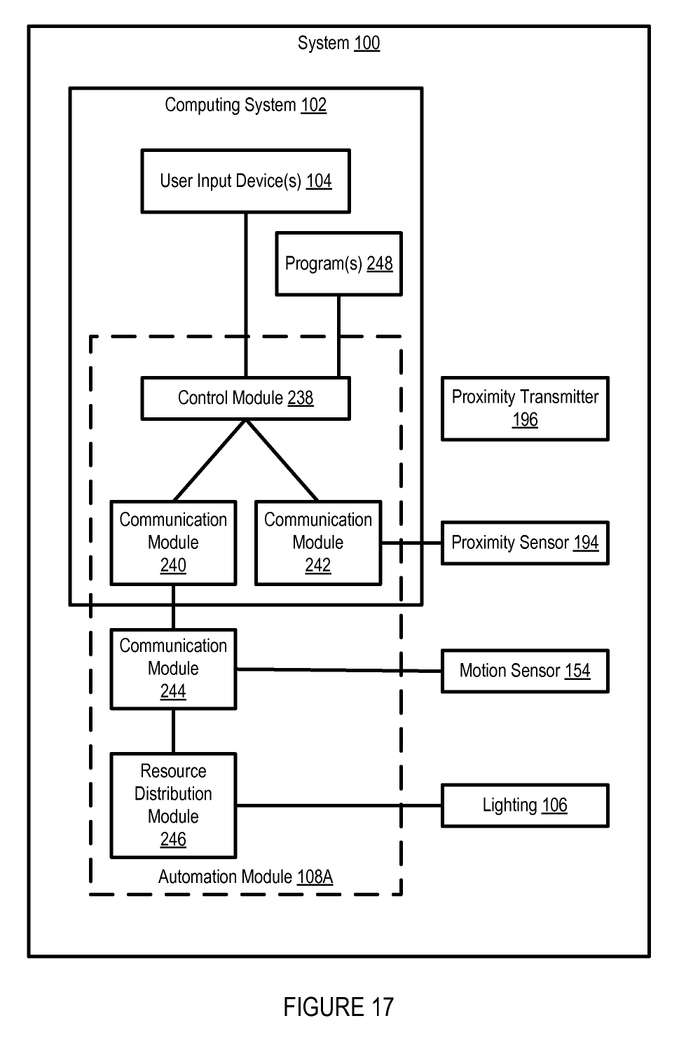

As shown in FIG. 17, the automation system 100 (FIGS. 1, 6, 11, and 16) may comprise an automation system in which the automation module 108 (FIGS. 1, 6, 11, and 16) may comprise an automation module 108A. The automation module 108A may comprise a control module 238; a communication module 240; a communication module 242; a communication module 244; a resource distribution module 246; one or more other suitable modules, systems, and the like; or any combination of one or more thereof. Of course, the automation module 108A may comprise other components; and the automation module 108A does not require the control module 238, the communication module 240, the communication module 242, the communication module 244, the resource distribution module 246, or any other particular component.

As discussed above, the automation system 100 may commence, maintain, and/or cease performing one or more automation actions—such as providing energy resources to a resource consuming device. For example, as shown in FIG. 17, the resource distribution module 246 is preferably configured to distribute electricity to the lighting 106. Advantageously, the communication module 244 may be configured to send commands to, check the status of, and receive notifications from the resource distribution module 246. In particular, the communication module 244 may be configured to command the resource distribution module 246 to commence distributing electricity to the lighting 106, to command the resource distribution module 246 to cease distributing electricity to the lighting 106, and to check the status of the resource distribution module 246 to determine whether the resource distribution module 246 is distributing electricity to the lighting 106.

In one embodiment, the control module 238 may comprise a software program. The communication module 240 may comprise a communication interface between the control module 238 and the communication module 244. Accordingly, via the communication module 240, the control module 238 may communicate with the communication module 244. Further, via the communication module 240 and the communication module 244, the control module 238 may send commands to, check the status of, and receive notifications from the resource distribution module 246. In one embodiment, the communication module 240 may be implemented using an ACTIVEHOME® Scripting Object, the communication module 244 may be implemented using an ACTIVEHOME® Professional Computer Interface (Product No. CM15A), and the resource distribution module 246 may be implemented using a LAMP MODULE™ (Product No. LM465). The ACTIVEHOME® Scripting Object, the ACTIVEHOME® Professional Computer Interface (Product No. CM15A), and the LAMP MODULE™ (Product No. LM465) are commercially available from X10 Wireless Technology, Inc. having offices at 19823 58th Place South, Kent, Wash. 98032, USA.

As discussed above, the automation system 100 may use a motion threshold to determine whether to commence, maintain, and/or cease performance of one or more automation actions. For example, as shown in FIG. 17, the motion sensor 154 is preferably configured to detect motion. Advantageously, the communication module 244 may be configured to send commands to, check the status of, and receive notifications from the motion sensor 154. In particular, the communication module 244 may be configured to check the status of the motion sensor 154 to determine if and/or when the motion sensor 154 has detected motion. As mentioned above, via the communication module 240, the control module 238 may communicate with the communication module 244. Accordingly, via the communication module 240 and the communication module 244, the control module 238 may check the status of the motion sensor 154, and perform one or more automation actions in response. In one embodiment, the communication module 240 may be implemented using an ACTIVEHOME® Scripting Object, the communication module 244 may be implemented using an ACTIVEHOME® Professional Computer Interface (Product No. CM15A), and the motion sensor 154 may be implemented using an EAGLEEYE™ Motion Sensor (Product No. MS14A). The EAGLEEYE™ Motion Sensor (Product No. MS14A) is also commercially available from X10 Wireless Technology, Inc. having offices at 19823 58th Place South, Kent, Wash. 98032, USA.

As discussed above, the automation system 100 may use a proximity threshold to determine whether to commence, maintain, and/or cease performance of one or more automation actions. For example, as shown in FIG. 17, the proximity sensor 194 is preferably configured to detect the proximity of the proximity transmitter 196. If desired, the communication module 242 may provide a communication interface between the control module 238 and the proximity sensor 194. Accordingly, via the communication module 242, the control module 238 may communicate with the proximity sensor 194, check the status of the proximity sensor 194, and perform one or more automation actions in response.

In one embodiment, the proximity sensor 194 may be implemented using a radio frequency identification (RFID) sensor, the communication module 242 may be implemented using a software interface adapted to communicate with the RFID sensor, and the proximity transmitter 196 may be implemented using an RFID transmitter that may be detected by the RFID sensor. Preferably, the proximity sensor 194 may wirelessly detect the proximity transmitter 196 via, for example, a wireless signal transmitted by the proximity transmitter. The proximity sensor 194 and the proximity transmitter 196 do not require RFID technology and any other suitable types of communication technologies may be used.

The control module 238 does not require the communication module 240, the communication module 242, or the communication module 244; and the control module 238 may be configured to directly communicate with the resource distribution module 246, the motion sensor 154, and/or the proximity sensor 194, if desired.

### Exemplary Detection/Monitoring of User Input

As discussed above, the automation system 100 may use a user input threshold to determine whether to commence, maintain, and/or cease performance of one or more automation actions.

If desired, an automation module (such as the automation modules 108, 108A) may be configured to monitor and/or to detect user input—which user input may be received, for example, via some, all, one, two, or more software programs 248 at least partially running on the computing system 102. For example, in one embodiment, the control module 238 of the automation module 108A may monitor and/or detect user input (such as, at the blocks 114, 116 in FIG. 2; at the blocks 160, 162 in FIG. 7; and at the blocks 202, 204 in FIG. 12).

An automation module may be configured to, at least partially in response to detecting (or not detecting) user input, “interface-independently” commence, maintain, and/or cease performance of one or more automation actions. As used herein, the phrase “interface-independently” means “independent of whether the user input was or was not received via any particular user interface of any particular software program and independent of whether the user input was or was not received via any particular user interface element of any particular software program.” Thus, at least partially in response to detecting (or not detecting) user input, an automation module may commence, maintain, and/or cease such performance independent of whether the user input was received (or was not received) via any particular user interface of any particular software program (such as, MICROSOFT WORD®, MICROSOFT INTERNET EXPLORER®, MICROSOFT WINDOWS®) and independent of whether the user input was received via any particular user interface element of any particular software program.

By interface-independently commencing, maintaining, and/or ceasing performance of one or more automation actions, an automation module (such as the automation modules 108, 108A) may advantageously commence, maintain, and/or cease such performance without requiring a user to select customized user interface elements of customized user interfaces that are specifically designed to schedule (or immediately trigger) that commencing, maintaining, and/or ceasing. Rather, the automation module may be configured to monitor a person's ordinary use of the computing system 102 in order to determine whether to commence, maintain, and/or cease performance of those automation actions. For example, an automation module may monitor a person's ordinary use of a word processor (such as MICROSOFT WORD®), an operating system (such as MICROSOFT WINDOWS®), and/or other software programs in order to determine whether to commence, maintain, and/or cease performance of those automation actions. Thus, persons need not be distracted from their ordinary use of the computing system 102 in order to commence, maintain, and/or cease performance of automation actions.

If desired, an automation module (such as the automation modules 108, 108A) may be configured to monitor and/or to detect “operating-system-level user input,” which comprises any user input that an operating system (such as, MICROSOFT WINDOWS®) of the computing system 102 and any software program 248 that runs on the operating system receives via one or more user input devices 104. For example, the control module 238 (FIG. 17) of the automation module 108A may be configured to monitor and/or to detect user input at the operating system level via some, all, one, two, or more of the user input devices 104; and, thus, the control module 238 may monitor and/or detect operating-system-level user input. In one embodiment, by monitoring and/or detecting operating-system-level user input, an automation module may interface-independently commence, maintain, and/or cease performance of one or more automation actions. However, an automation module need not monitor and/or detect operating-system-level user input in order to interface-independently commence, maintain, and/or cease performance of one or more automation actions.

If desired, an automation module may be configured to monitor and/or detect user input via event-driven programming. For example, the control module 238 (FIG. 17) of the automation module 108A may monitor and/or detect user input via event-driven programming, and may perform one or more automation actions upon the occurrence of one or more user input events. In one embodiment, the one or more user input events may be operating-system user input events, which may be used to monitor and/or to detect operating-system-level user input. In one embodiment, the one or more user input events may be used to interface-independently commence, maintain, and/or cease performance of one or more automation actions. However, event-driven programming is not required in order to monitor or detect operating-system-level user input or any other user input; and event-driven programming is not required in order to interface-independently commence, maintain, and/or cease performance of one or more automation actions.

### Exemplary Architecture

The methods and systems described above can be implemented using software, hardware, or both hardware and software. A module may include the software, the hardware, or both—including but not limited to software components, object-oriented software components, class components and task components, processes, functions, attributes, procedures, subroutines, segments of program code, drivers, firmware, microcode, circuitry, data, databases, data structures, tables, arrays, variables, field programmable gate arrays (FPGAs), application-specific integrated circuits (ASICs), controllers, computers, and firmware—to implement those methods and systems described above. The functionality provided for in the software, hardware, or both may be combined into fewer components or further separated into additional components. Additionally, the components may advantageously be implemented to execute on one or more devices.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The methods and systems described above require no particular component or function. Thus, any described component or function—despite its advantages—is optional. Also, some or all of the described components and functions may be used in connection with any number of other suitable components and functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An automation system comprising:
an automation module configured to detect whether a computing system received first manually-entered user input via at least one manual user input device;
and to, at least partially in response to detecting that the computing system received the first manually-entered user input, interface-independently trigger the brightening of lighting.

2. The automation system as in claim 1, wherein the automation module is further configured to detect whether the computing system received, within a defined time period, second manually-entered user input via at least one manual user input device; to, at least partially in response to detecting that the computing system received the second manually-entered user input within the defined time period, interface-independently keep the lighting brightened; and to, at least partially in response to detecting that the computing system did not receive the second manually-entered user input within the defined time period, interface-independently trigger the darkening of the lighting.

3. The automation system as in claim 1, wherein the first manually-entered user input comprises mouse movement.

4. The automation system as in claim 1, wherein the first manually-entered user input comprises at least one keystroke.

5. The automation system as in claim 1, wherein the automation module is further configured to, at least partially in response to detecting that the computing system received the first manually-entered user input, interface-independently trigger a heating, ventilation, air conditioning (HVAC) system to provide air flow.

6. The automation system as in claim 5, wherein the automation module is further configured to detect whether the computing system received, within a defined time period, second manually-entered user input via at least one manual user input device; to, at least partially in response to detecting that the computing system received the second manually-entered user input within the defined time period, interface-independently keep the HVAC system providing the air flow; and to, at least partially in response to detecting that the computing system did not receive the second manually-entered user input within the defined time period, interface-independently trigger the HVAC system to cease providing the air flow.

7. The automation system as in claim 5, wherein the automation module is further configured to detect whether a motion sensor detected motion; and to trigger the HVAC system to provide air flow at least partially in response to detecting that the motion sensor detected motion.

8. The automation system as in claim 7, wherein the automation module is further configured to detect whether a proximity sensor detected proximity; and to trigger the HVAC system to provide air flow at least partially in response to detecting that the proximity sensor detected proximity.

9. The automation system as in claim 7, further comprising the computing system, the at least one manual user input device, the lighting, the HVAC system, the motion sensor, and the proximity sensor.

10. An automation method comprising:
detecting whether a computing system received manually-entered user input via at least one manual user input device; and
at least partially in response to detecting that the computing system received manually-entered user input via at least one manual user input device, interface independently triggering the brightening of lighting.

11. The automation method as in claim 10, further comprising:
at least partially in response to detecting that the computing system received manually-entered user input via at least one manual user input device, interface-independently triggering a heating, ventilation, air conditioning (HVAC) system to provide air flow.

12. The automation method as in claim 10, wherein the manually-entered user input comprises mouse movement.

13. The automation method as in claim 10, wherein the manually-entered user input comprises at least one keystroke.

14. An automation method comprising:
detecting whether a computing system received manually-entered user input via at least one manual user input device; and
at least partially in response to detecting that the computing system did not receive manually-entered user input via at least one manual user input device, interface independently triggering the darkening of lighting.

15. The automation method as in claim 14, further comprising:
at least partially in response to detecting that the computing system did not receive manually-entered user input via at least one manual user input device, interface-independently triggering a heating, ventilation, air conditioning (HVAC) system to cease providing air flow.

16. The automation method as in claim 14, wherein the manually-entered user input comprises mouse movement.

17. The automation method as in claim 14, wherein the manually-entered user input comprises at least one keystroke.

18. An automation method comprising:
detecting whether a motion sensor detected motion; and
at least partially in response to detecting that the motion sensor detected motion, triggering a heating, ventilation, air conditioning (HVAC) system to provide air flow.

19. The automation method as in claim 18, further comprising:
detecting whether a computing system received manually-entered user input via at least one manual user input device; and
at least partially in response to detecting that the computing system received manually-entered user input via at least one manual user input device, interface independently keeping the HVAC system providing the air flow.
